(19) United States
(12) Patent Application Publication
(10) Pub. No.: US 2018/0227403 A1
(43) Pub. Date: Aug. 9, 2018

(54) System and Method for Identifying Potential Contact and Inviting Transmission of Contact Information Based on Proximity to a Location

(71) Applicant: Mark Kenney, Allen, TX (US)

(72) Inventor: Mark Kenney, Allen, TX (US)

(21) Appl. No.: 15/889,577

(22) Filed: Feb. 6, 2018

Related U.S. Application Data
(60) Provisional application No. 62/456,913, filed on Feb. 9, 2017.
(60) Provisional application No. 62/516,480, filed on Jun. 7, 2017.

(51) Int. Cl. H04M 1/2745; H04W 4/02

(52) U.S. Cl. CPC H04M 1/274533; H04W 4/023

(57) ABSTRACT

A communication system and method for exchanging wireless device user contact information based on a user's proximity to a predetermined radius that each user sets from the user initiating contact or on a user's presence within a boundary of a predefined location. The users sending and receiving the offers or messages can be subscribers of an information exchange service via an application program downloaded to the user's portable device that allows automatic receipt and acceptance of offers to exchange contact information.

This application claims priority to pending Provisional Patent Application No. 62/456,913 filed Feb. 9, 2017 and pending Provisional Patent Application No. 62/516,480 filed Jun. 7, 2017, both of which are incorporated by reference in their entireties.

### BACKGROUND OF THE INVENTION

The present disclosure is directed to systems and methods for users of portable communication devices, such as smart phones or tablets that communicate via a wireless communication protocol to identify other device users and extend an offer to exchange user information or send messages. Users to which such offers or messages are sent can be determined based on a predetermined radius that each user sets from the user initiating contact or within a boundary of a predefined location. The presently described system and method also can include an offline feature. In the offline mode of operation, a user who is within the predetermined radius or established boundary but not within a location's wireless communication network, such as WiFi, can interact with the communication platform but can be required to re-enter the WiFi network range or otherwise log into the WiFi network before accepting an invitation to connect. The users sending and receiving the offers or messages can be subscribers of an information exchange service via an application program downloaded to the user's portable device.

The systems and methods described herein allow users to connect and share business and/or personal information with others electronically in an easy, efficient, immediate and accurate manner. There is a need for such systems and methods to replace the antiquated, inaccurate and inefficient ways that people exchange information, such as exchanging business cards that are either lost or require later entry into the recipient's hard copy or electronically stored contact list. Or, the recipient attempts to commit a newly met person's contact information to memory, which is often forgotten, costing the recipient of the contact information to lose an opportunity.

The presently described systems and methods can be used both in a business or personal contact. Users can initiate contact and offer an information exchange based on a wide variety of parameters ranging from simply common attendance at an event or more refined profile information that serves as a filter to limit the sending or receiving of offers to connect based on the profile information. The described systems and methods can be employed in various contexts. One such context is a networking event for real estate agents. Users of portable devices who are subscribers of the application program residing on the device in attendance at such an event may identify other subscribers at the event located within a user defined distance from the user or within a predefined boundary of a location. For example, a user through the application program may set a predefined distance that serves as radius from the user. Using various techniques such as geo-fencing, near field communication (NFC), global positioning system (GPS) capability, indoor positioning technology, Bluetooth or other wireless communication capability enabled through the user's portable device and/or the subscriber application program, the user may identify other subscribers within the predefined area. In one embodiment, the application program executes machine readable instructions that provide a graphical image on the subscribing user's device that identifies a location of subscriber users within the predefined distance or boundary. Once the presence of potential contact at the event is identified to the user, the user can decide whether to send an offer to exchange information with the identified person or persons. In the alternative, a user may apply a setting that automatically sends contact information to any other subscribers that come within the predefined area and request to receive the identified person's contact information.

Through a dedicated application program, this identification of another subscriber within the predefined zone can include an indication of the name of the identified contact and a photograph. The subscribers can then exchange more detailed contact information through simple commands selected via the application program on each subscriber's device. Once contact information is exchanged, further communications such as transmitting a text message or placement of a call are facilitated. Users can also record video through the application software and associated recording device and exchange the video with other users. Once the recipient of the video views the video, the sender is so notified. The extent of information exchanged automatically in this manner upon entry within the predefined distance or border can be predefined by subscribers. That is, a user can opt for her smart phone number to be given to any subscriber (which may be common at events such as events attended exclusively by real estate agents). Alternatively, the user can be more selective in providing automatic contact information based on certain parameters set by the user. Depending on the circumstances, a user can opt to prevent any information to be provided or even disable the ability to be identified within another user's predefined area.

Similarly, a subscriber of the presently described system can set parameters as a recipient of contact information. A user can select parameters that will filter the list of received contact invitations or automatically accept contact information if there is a match between an attribute of a sender of received contact information and a pre-defined parameter or attribute set by the receiving subscriber. In some contexts, a subscriber expecting to receive several contact invitations, especially within a short time frame, may designate automatic acceptance and storage of received contact information from senders matching a pre-defined parameter. Further, a subscriber may set a parameter that invokes automatic acceptance and storage of received contact information from senders coming within a radius or particular distance from the subscriber. This prevents the subscriber from pausing to manually accept invitations to connect one-by-one when face to face interaction at an event make such pauses difficult.

The parameters that a user can select to share or to serve as a filtering function can include business and personal information, with the level of granularity determined by the user's selections. Such parameters may include information commonly entered by subscribers of various social media or networking sites such as LinkedIn or Facebook in which individual data such as “Groups” in which a user is a member or “Likes” of a person may serve as parameters for subscribers. Parameters can also include a user's personal characteristics and information such as hobbies, interests or skills and matching algorithms can be applied to execute the filtering process.

In one embodiment, a user may include a high level profile item, such as a photograph or name that will automatically appear on another user's device to assist with identification of that user. Once a user is identified, a user, such as an attendee at an event, can ask another attendee to connect by simply depressing a “connect” key on the phone. Each user has the option to send business information (e.g., company name, business phone number and address) and personal information (e.g., spouse, children's names, city of residence, etc.). Through this contact, a user can also connect with another identified subscriber via a social network platform, such as Facebook, Linkedin, Twitter or various others. The application program downloaded to the user's device containing machine readable code to execute the functions and methods described herein can include presenting connecting users with links to various social media platforms for which the sending user is a member and allow the receiving user to view the sender's social media page and further connect via the social medal platforms. Based on parameters set by a user, these offers to connect and exchange information may be transmitted by a single operation on the user device, such as depression of a single key.

Once an identified user receives a request to connect in one of the various forms described above (assuming such user has not in advance blocked such a request), the identified user can accept or decline the request. In an embodiment the recipient can accept or reject the invitation to connect with a single operation on the receiving user device, such as a depression of a single key.

If recipient user accepts the offer to connect, the sending user will automatically receive the other user's contact information and the offering user's contact information will be sent to the invited user. The transmitted and received contact information can be securely stored in the cloud, other remotely located storage device, and locally on the user's device including the smart phone's native contact address book. Once the users are connected, more in depth invitations may be sent such as those to connect via various social network platforms. Subscribers that connect can exchange a link to their respective social media pages through the dedicated application program allowing one subscriber to join another's network. Upon activation of the link and based on previous settings by the subscriber, the subscriber can be logged into her social media page when opening the link. Otherwise, the subscriber is directed to a login page when activating the link, where the subscriber can enter her user name and password for the social media site. Once subscribed users connect, a contact is automatically created on the other user's mobile phone.

The systems and methods of the mobile user contact invitation system described herein permits selective, real-time creation of contacts electronically. In addition, once a user accepts an invitation to connect and two users are connected, any updates to one user's contact information will cause an automatic update of that user's contact information for other connected users, whether the contact information is stored or backed up to cloud storage, remote storage or locally on the mobile device.

In another embodiment, businesses can employ the boundary capabilities described above to quickly and efficiently collect required information from a customer. In a physician's office employing the functionality described above in connection with users at a networking event, a patient who has a dedicated application on her mobile device will receive an invitation to provide information to the physician's office in connection with the visit. When the patient enters the boundary of the physician's office of facility, the patient will receive an invitation to submit information that the physician requires prior to the visit. The patient may in advance identify personal information that she is willing to submit to the physician in advance by this method, either submitting some, all or none of the requested information.

Similarly, for recreational establishments in which the owner wishes to obtain a waiver or other information from patrons, the applications described herein can be utilized via a mobile device to send an invitation to submit the requested information once the user enters a boundary of the establishment or comes within a particular distance to the point of sale or check in. Also, event venues requiring parents to provide permission slips and information for participating children can also employ the application program described herein on their mobile devices to request the necessary information once the patrons enter the facility or physically reach a certain location. For those who frequent these establishments, the type of information required is known in advance and often common among different types of establishments requiring parental consent. The methods and systems described herein result in a reduction of wasting time in line to fill out paper forms.

### BRIEF DESCRIPTION OF THE DRAWINGS

The invention and a preferred mode of use, further objectives and advantages thereof, will be best understood by reference to the following detailed description of illustrative embodiments when read in conjunction with the accompanying drawings, wherein:

FIG. 1 depicts a network diagram according to an embodiment of the present contact identification and invitation system.

FIG. 2 depicts various locations of users of an embodiment of the present contact identification and invitation system.

FIG. 3 depicts a method of requesting and receiving information from users according to an embodiment of the present contact identification and invitation system.

### DETAILED DESCRIPTION

Several embodiments of the invention will now be described with reference to the drawings. Unless otherwise noted, like elements will be identified by identical numbers throughout all figures. The invention illustratively disclosed herein suitably may be practiced in the absence of any element which is not specifically disclosed herein.

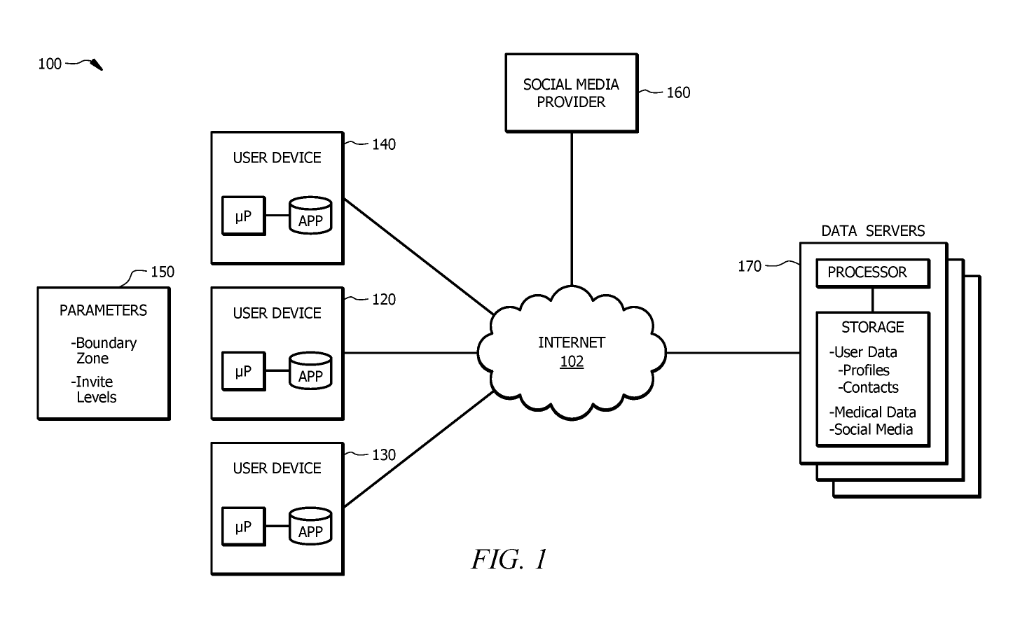

FIG. 1 depicts a network diagram according to an embodiment of the present contact identification and invitation system. In FIG. 1, contact identification and invitation network 100 includes multiple user devices 120, 130 and 140. Each such user device may be a smart phone, tablet or other mobile device enabled to communicate over a communication network or locally with other devices via various protocols, such as cellular, Bluetooth, WiFi and the like. User devices 120, 130 and 140 include a processor for executing machine readable instructions and storage on which application programs and other data, such as contact information, photographs, etc. may be stored. User devices can also include an antenna, internal hardware and other application programs enabling location information to be provided and or received by the user device. This can include GPS components or application programs enabling a user through the device to invoke a geo-fencing operation associated with a known location or internal positioning system applications. These applications and/or hardware that enable a user to select the boundary of a known location or set a predefined radius of interest from the user can be cloud based or downloaded locally on the user device.

Various wireless technology can be used for identifying and locating a potential contact. Many different systems take advantage of existing wireless infrastructure for indoor positioning. There are three primary system topology options for hardware and software configuration, network-based, terminal-based, and terminal-assisted. Positioning accuracy can be increased at the expense of wireless infrastructure equipment and installations. A WiFi position system (WPS) can be used where GPS may be inadequate indoors. The localization technique used for positioning with wireless access points is based on measuring the intensity of the received signal and can employ a method of “fingerprinting”. Some parameters useful to geo-locate the WiFi hotspot or wireless access point include the SSID and the MAC address of the access point to rapidly map indoor spaces and that won several awards for its location accuracy. Bluetooth enabled device can provide a geo-fence or indoor positioning capability solution.

In one embodiment of the present system, the person in receipt of an invitation to connect from a subscriber of the contact identification and invitation system is also a subscriber. It is contemplated, however, that a subscribed user can initiate contact and send information to another person who is not a subscriber and does not have the application stored on his or device. For such unsubscribed users, the subscriber can send an email or text message with the sender's contact information. The sending person can obtain the receiving person's email or phone number by asking the receiving person or otherwise obtaining the information. The receiving person can click on an attachment within the email or text and store that information in his smart phone contact address book. The message can also include an invitation for the receiving user to register and become a subscriber to the application of the present contact identification system.

Within storage of user devices 120, 130 and 140 are parameters 150 entered by the user or otherwise made available for use with the present contact identification and invitation system. These parameters can include invite levels or filtering information set by the user and coverage zone information, such as a distance from user (radius) or physical address boundary setting. The physical address boundary setting may be established through a web based map provider, such as Google maps or the like.

Each user device that is subscribed to the present contact identification and invitation system can be in communication with data servers 170 over a wide area network 102, such as the internet. Data servers 170 include a processor and storage. Among other things, data servers provide cloud-based storage of information pertinent to users subscribed in the present contact identification and invitation system. This includes user enrollment data, user profiles, contact information, medical data, and social network information such as likes, groups joined and the like. Various social media platforms 160 may be communicated with by data servers and user devices through application programs of the contact identification and invitation system.

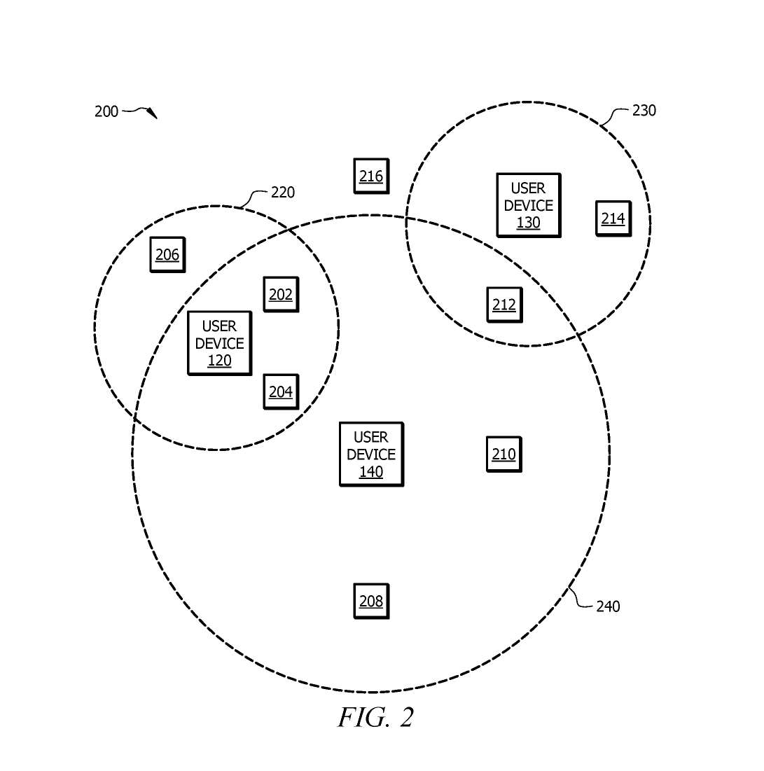

FIG. 2 depicts the location 200 of the various user devices 120, 130 and 140 within a predefined boundary established by each device user according to an embodiment of the present contact identification and invitation system. As shown, each user of a user device via an application program stored on the device can establish a boundary 220, 230 and 240 associated with each respective user device 120, 130 and 140. As seen, the boundary represents a region in which other device users subscribed to the contact identification and invitation system must enter in order to invoke the process by which offers to exchange information is made. As shown in FIG. 2 various user of mobile devices present at an event, for example, are located within the various boundaries set by user devices 120, 130 and 140. Users 202, 204 and 206 are located within the set boundary 220 of user device 120. Users 212 and 214 are located within the set boundary 230 of user device 130. Users 202, 204, 208, 210 and 212 are located within the set boundary 240 of user device 140. Note that users 202 and 204 are located within both set boundaries 220 and 240. Likewise, user 212 is located within both set boundaries 230 and 240. Also, user 216 is located within no set boundary.

In the alternative to the radius based boundaries 220, 230 and 240, the user may select the physical boundary of a known place, such as a facility hosting an event that is viewable via a web-based map. The users shown in FIG. 2 coming within at least one set boundary and who are subscribers to the contact identification and invitation system cause the corresponding subscriber user device 120, 130 or 140 to recognize the user so entering the boundary and invoke the invitation process. In addition, a subscriber can search for the name, phone, email, characteristics of another subscriber and send an invitation, regardless of whether latter comes within the preset boundary.

As described, a subscriber of the presently described system can set parameters as a recipient of contact information. A user of device 120, 130 or 140 can select parameters that will filter the list of received contact invitations or automatically accept contact information if a particular invitation sender's attribute matches a previously selected parameter of a sender set by the recipient of the contact information. In certain settings a subscriber may expect to receive contact invitations from many people of interest, often within a short time span. As such, a user may designate automatic acceptance and storage of received contact information from senders matching a pre-defined parameter. Further, a subscriber may set a parameter that invokes automatic acceptance and storage of received contact information from senders coming within a radius or particular distance from the subscriber. This automatic acceptance and storage feature eliminates the need of the subscriber to pause and manually accept invitations to connect one by one when face-to-face interactions at an event make such pauses difficult.

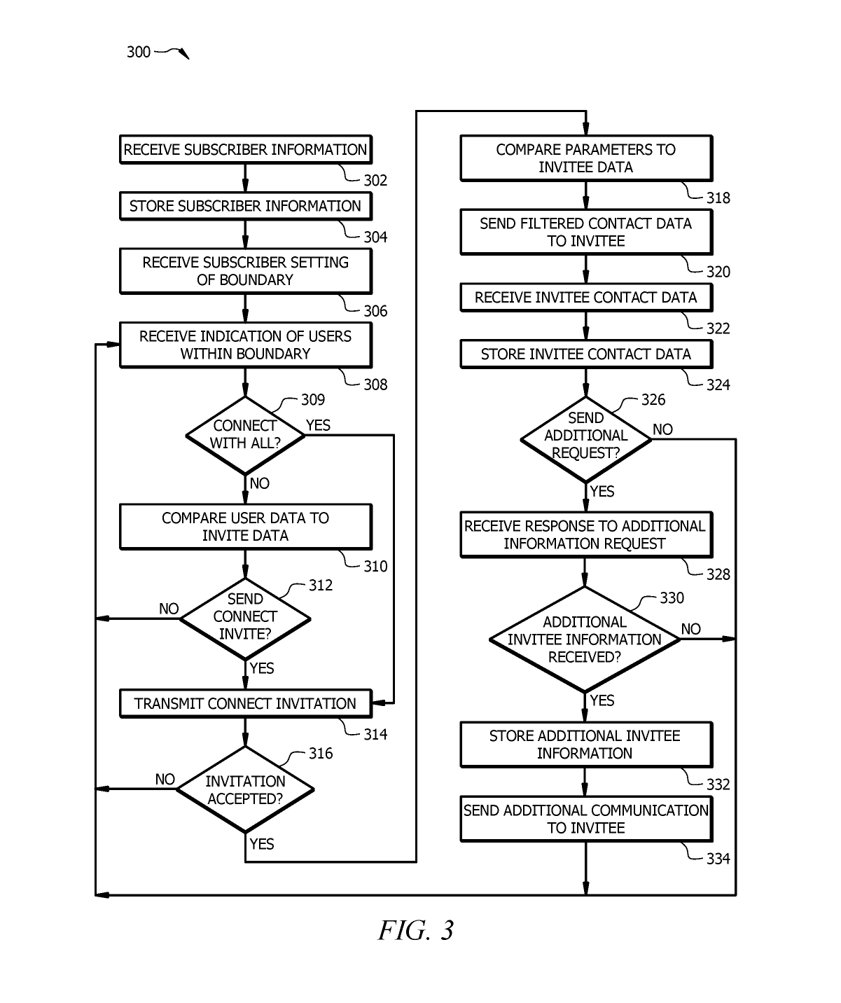

FIG. 3 is a flowchart of a contact identification and invitation process according to an embodiment of the present invention. The steps of methods described can be performed by one or more application programs comprising machine readable instructions residing on a user device or accessed remotely. In FIG. 3, the contact identification and invitation process begins at step 302 where the contact identification and invitation system receives subscriber information. This information includes various enrollment information and parameter information that a subscriber can use to filter information received by potential contacts or for potential contacts to determine if they want to connect with that subscriber. At step 304, the parameter information is stored locally in storage of the subscriber's user device and/or in data servers 170. Once a user is subscribed and various information is entered and stored, the user wishing to connect to other users may enter a boundary setting. At step 306, the system receives from the user device a boundary setting. This may consist of entry of a distance from the subscriber user that serves as a radius from the subscriber creating a virtual boundary around the subscriber as shown in 220, 230 and 240 of FIG. 2. The GPS capability of a potential contacts user device will be leveraged to indicate that user's presence within the boundary. In the alternative, other forms of indoor location systems, geo-fencing systems or other device location systems known in the art may be employed to set the boundary and provide an indication of when a person or device enters the boundary.

Next at step 308 the subscriber receives an indication that a user who is a potential contact is within the subscriber's predetermined boundary. This indication of boundary entry by a person can be a simple message, an audio indicator or a graphical representation provided to the user via the user device's user interface display that provides the subscriber with a mapping of the area. This mapping allows the subscriber to attempt to see the potential contact within the boundary and determine whether additional contact efforts will be pursued.

The subscriber through the application program can select a “connect with all” command at step 309 that starts the contact initiation process described in FIG. 3 in parallel with each person entering the boundary. Depending on the event or other circumstances, the subscriber can forego the further filtering process of potential contacts described above in whole or in part and simply send to every user within the boundary contact information, social media information and other information and request reciprocal information. At step 309 the system queries whether the user invokes the “connect with all” option. The “connect with all” option can take various forms. In one embodiment, a user can pre-set parameters to send contact information to any other subscriber that comes within a pre-defined distance of the user. This transmission can be automatic without the user depressing any keys on the device or selecting any commands. Similarly, a user may set a parameter that automatically causes acceptance of any contact invitation received from a person within the pre-defined distance or boundary and storage of the sender's corresponding contact information among the user's contacts. If such automatic acceptance occurs, the user's contact information can be automatically sent in kind to the person within the boundary range. The parameter that invokes automatic or “hands free” acceptance of the contact invitation can also be based on a different parameters, such as name, employer, distance, etc. If automatic acceptance is so designated, the process of FIG. 3 may return to step 308 at this juncture as contact information has been exchanged and accepted by the user for every individual meeting the pre-set criteria, such as distance from the user. If the answer to the query at step 309 is yes (but automatic acceptance has not been invoked), then the method proceeds to step 314 to transmit the invitation to connect to all of those identified within the boundary.

If the answer of query 309 is no then the process continues with step 310. At step 310, the potential contact's profile data is compared to invite level data previously stored by the subscriber. This comparison serves as a filtering mechanism that allows the subscriber to determine if the contact will be pursued. For example, if the subscriber has set certain minimum requirements that must be met prior to sending an invitation to connect, then no invitation will be sent until those requirements are met. These include a potential contact's place of business, type of business, location of business, university attended, interests, social media information and the like. As this filtering relies on information from the potential contact that was entered and stored by the potential contact when he or she subscribed to the contact identification and invitation system. The potential contact, however, could deactivate this feature and no parameter data will be provided to the inviting subscriber.

Following the comparison of the potential contact data to the subscriber's invite level data, the system queries at step 312 if the subscriber would like to send the potential contact an invitation to connect. If the answer to this question is “no”, then the method returns to step 308 for the subscriber to consider whether an invitation to connect will be sent to the next potential contact. If, on the other hand, the answer to this question is “yes”, then the method continues to step 314 where an invitation to connect is transmitted from the subscriber to the potential contact. The subscriber's device transmits a message displayed on the potential contact's user device with or without an image of the subscriber through the contact identification and invitation application stored in the subscriber's device.

Once the potential contact receives the invitation, the subscriber awaits a response. At step 316, the method continues with the query of whether the subscriber's invitation was accepted by the potential contact. If the answer is “no”, the method returns to 308 for the subscriber to consider whether an invitation to connect will be sent to the next potential contact. If, on the other hand, the invitation is accepted, the method continues with step 318 where the subscriber's parameter data is compared to the contact's parameter data. This is another layer of filtering used to determine the extent of the information that the subscriber wishes to exchange with the contact. Based on similarities between the subscriber's parameter data and the contact's parameter data, at step 320 the subscriber sends the resulting level of contact information to the contact. In return, and in one embodiment according to a comparison between the contact's parameter data and the parameter data of the subscriber, the method continues at step 322 where the subscriber receives the contact's contact data. This data may be as limited as a cell phone number, name or place of business or more extensive data based on the contact's settings. The data received at step 322 can include an invitation to connect on various social media platforms, the connection capability being facilitated by the contact identification and invitation system application stored on the user device, by sending a link to the inviting user's social media page through which the invited user can further connect. This eliminates the need for the invited user to search for the other's social media presence. The subscribing user, however, can include the link to social media pages as part of an initial contact message or any subsequent exchange during the connection process. The contact identification and invitation system described herein provides users with numerous capabilities to customize the content of an initial invitation to connect and subsequent exchanges with an invitee. At step 324, the contact's contact data is stored in the subscriber's device and/or remotely on cloud storage on data servers 170 or other remote storage device that permits retrieval by the subscriber and locally on the device. At step 326, after some level of contact information is exchanged, the system queries whether the subscriber wishes to send an additional request. If the answer to this query is “no”, then the method again reverts back to step 308 for the subscriber to consider whether an invitation to connect will be sent to the next potential contact.

If, on the other hand, the answer to this query is “yes”, then the additional request is sent and the subscriber receives some response to this additional request at step 328. Next, at step 330, the system queries whether any additional information was received by the subscriber from the contact. If the answer is “no”, then the process returns to step 308 for the subscriber to consider whether an invitation to connect will be sent to the next potential contact. If the answer is “yes”, then the contact's additional information is then stored at step 332. This may be in the form of further contact information of the type that a user saves in “contacts” on a phone or other device. The previously stored contact information, therefore, is updated. Or an electronic contact can be saved for the first time on the subscriber device if this is the subscriber's first receipt of information from the contact that is sufficient to create a contact file for this contact. The additional information can be in the form of a photo or other image of data such as an image of a business card or other document. Once the additional information received is stored by the subscriber at step 332, at step 334 the subscriber may send an additional communication to the contact, such as a text message, place a call or send another message or information to the contact via the messaging capability associated with the contact identification and invitation application. The process then returns to step 308 where the inviting subscriber determines whether an invitation to connect will be sent to the next potential contact.

In another embodiment, in the case where automatic acceptance and storage of a received contact is invoked, the further exchange of information between the subscribers initially connected by the automatic feature can take place according to the steps described above. The subsequent exchange of additional information such a photo or image data, or social media platform invitations may be exchanged as described in FIG. 3.

In the method described above, the sending and receiving steps can occur in both directions, as in one embodiment both the inviting user and the invited user are subscribers. In other embodiments, various steps of the disclosed method of FIG. 3 can be employed in a business setting as described above, such as a physician's office for the patient to provide required information to the physician via the contact identification and invitation system application. In this context, the patient coming in close proximity to the physician's office will invoke the method and cause the patient to receive a request to submit information to the physician through the patient's device. Similarly, in various entertainment venues where participant information or waivers are required from patrons or parental consent forms and information are required for child participation, the methods described above can be performed for fast and efficient receipt of customer data by the establishment prior to the customer reaching the point of payment or entry. This eliminates long lines and bottle necks that are common at such venues.

The foregoing description is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

While the disclosed embodiments have been described with reference to one or more particular implementations, these implementations are not intended to limit or restrict the scope or applicability of the invention. Those having ordinary skill in the art will recognize that many modifications and alterations to the disclosed embodiments are available. Therefore, each of the foregoing embodiments and obvious variants thereof is contemplated as falling within the spirit and scope of the disclosed inventions.

While the invention has been particularly shown and described with reference to a preferred embodiment, it will be understood by those skilled in the art that various changes in form and detail can be made therein without departing from the spirit and scope of the invention.

I claim:

1. A method for initiating communication with a wireless device according to a geographic location, comprising:
identifying a geographic boundary into which a targeted sender's wireless communication device having a contact information enters;
selecting, by a recipient's wireless communication device, at least one of a plurality of attributes of the targeting sender;
receiving the contact information of the targeted sender upon entry of the targeted sender into the geographic boundary; and
automatically storing the contact information of the targeted sender in storage associated with the recipient's wireless communication device upon a match of the selected at least one of the plurality of attributes of the targeted sender and a targeted sender attribute.
